(19) United States
(12) Patent Application Publication
(10) Pub. No.: US 2018/0165987 A1
(43) Pub. Date: Jun. 14, 2018

(54) SYSTEM FOR LEARNING A LANGUAGE

(71) Applicant: David Alejandro Montiel, Berlin (DE)

(72) Inventor: David Alejandro Montiel, Berlin (DE)

(21) Appl. No.: 15/831,595

(22) Filed: Dec. 5, 2017

Related U.S. Application Data
(60) Provisional application No. 62/431,628, filed on Dec. 8, 2016.

(51) Int. Cl. G09B 19/06; G09B 5/06

(52) U.S. Cl. CPC G09B 19/06; G09B 5/06

(57) ABSTRACT

A system for learning a language. The system embodies a display medium adapted to simultaneously represent a learning language and a first, native language, synchronizing the representation of each language as a graphical text, as audio output of the graphical texts, and as a visual output indicating the current position in the graphical text so that a user may selectively control the display of audio and visual output associated with each language.

### CROSS-REFERENCE TO RELATED APPLICATION

This application claims the benefit of priority of U.S. provisional application No. 62/431,610, filed 8 Dec. 2016, the contents of which are herein incorporated by reference.

### BACKGROUND OF THE INVENTION

The present invention relates to systems for learning a language and, more particularly, a system embodied in a display medium adapted to simultaneously represent a first, known language and a second language a user desires to learn more about. The display medium enables the user to selectively control the display of the audio and visual output associated with each language.

Current methods of learning a new language generally includes reading texts in the new language with no contextual reference defined by the reader's first language, and as a result the reader misses some words by not having a native-language context to complete the idea incorporated in the reading.

Furthermore, having a text in a foreign language that you partially understand yet still having to use a dictionary or similar external reference to get the definition to one of the words is time consuming. Moreover, it is distracting to have to open a dictionary software application and copy/paste the word that you are trying to comprehend when reading a text in a different language. Typically resulting in losing one's place in the second language text.

As can be seen, there is a need for a display medium adapted to simultaneously represent a first language and a second language so that a user may engage in parallel reading in the two languages, sentence by sentence. Furthermore, there is a need for the display medium to provide simultaneous audio representation of each language. Moreover, an advantage over the pre-existing teaching methods is realized by the display medium visually indicating the current position in the text while at the same time maintaining synchronicity with the reproduction of the associated audio representational output, so that users can utilize their first, native language as a reference to understand the new second language text, all while the user stays on the same screen, not having to change to another software application or other external reference during the learning process.

### SUMMARY OF THE INVENTION

In one aspect of the present invention, a system for teaching a language includes a display device displaying at least one block of second language data in synchronization with a reproduction of audio output associated with the at least one block of second language data; a form of memory coupled to the display device, wherein a block of first language data translated in response to each of the at least one block of second language data is retrievable stored so that each block of first language data is selectively displayable on the display device simultaneously with said display of the at least one block of second language data; and an animation generator for generating output signals representing a current language position within each block of first and/or second language data associated with the reproduction of audio output.

In another aspect of the present invention, the system for teaching a language includes a display device displaying at least one block of second language data in synchronization with a reproduction of audio output associated with the at least one block of second language data; a form of memory coupled to the display device, wherein a block of first language data translated in response to each of the at least one block of second language data is retrievable stored so that each block of first language data is selectively displayable on the display device simultaneously with said display of the at least one block of second language data; an animation generator for generating output signals representing a current language position within each block of first and/or second language data associated with the reproduction of audio output, wherein the output signals are visual indicators displayed on the display device adjacent to the current language position; and control inputs operatively associated with the display device, wherein the control inputs are configured selectively display each block of second language data adjacent to each said block of first language text, wherein the display device is configured to highlight each block of first and second language text simultaneously.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention, illustrating highlighting modalities a parallel reading enablement;

FIG. 2 is a schematic view of an exemplary embodiment of the present invention;

FIG. 3 is a schematic view of an exemplary embodiment of the present invention, illustrating audio output and visual output/animation; and

FIG. 4 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the present invention.

Broadly, an embodiment of the present invention provides a display medium adapted to simultaneously represent a learning language and a first, native language, synchronizing the representation of each language as a graphical text, as audio output of the graphical texts, and as a visual output indicating the current position in the graphical text so that a user may selectively control the display of audio and visual output associated with each language.

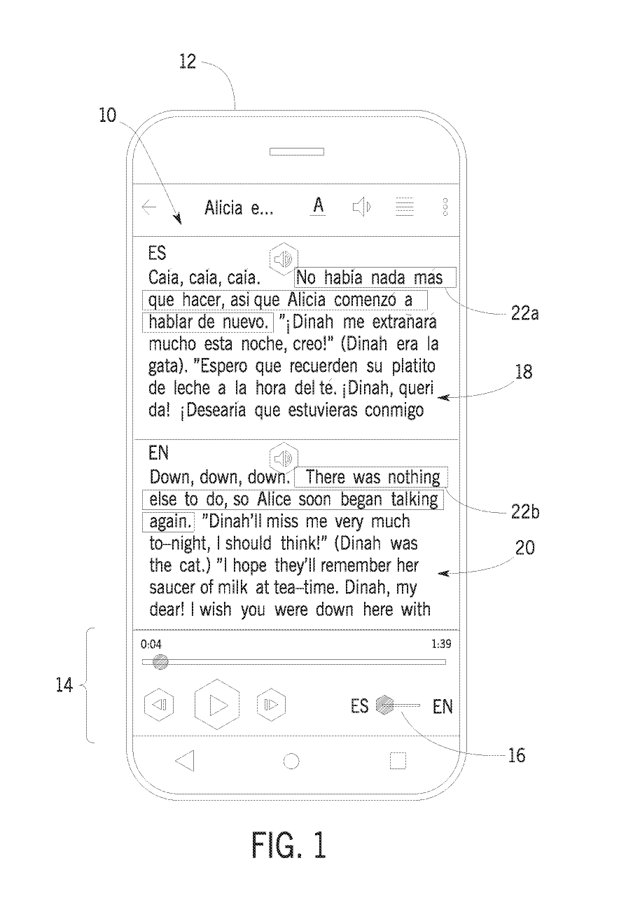

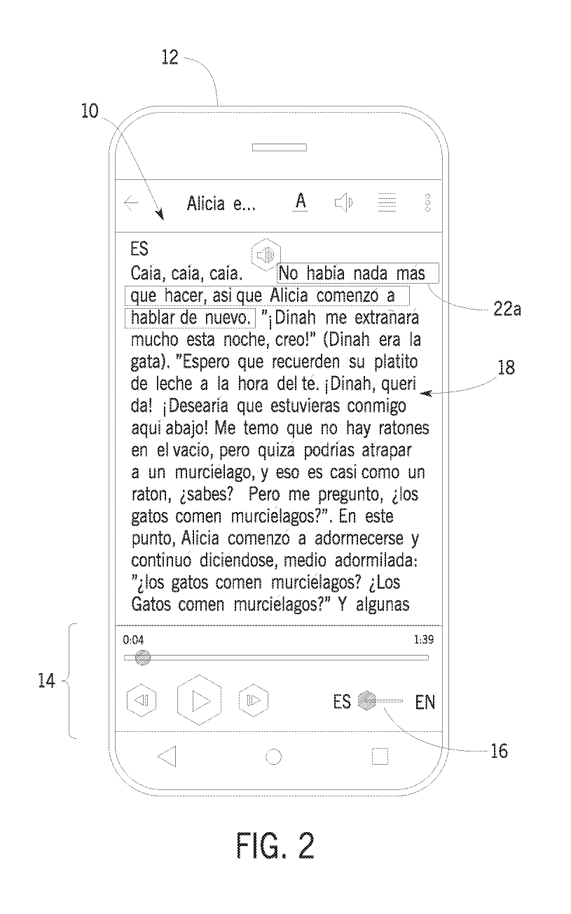

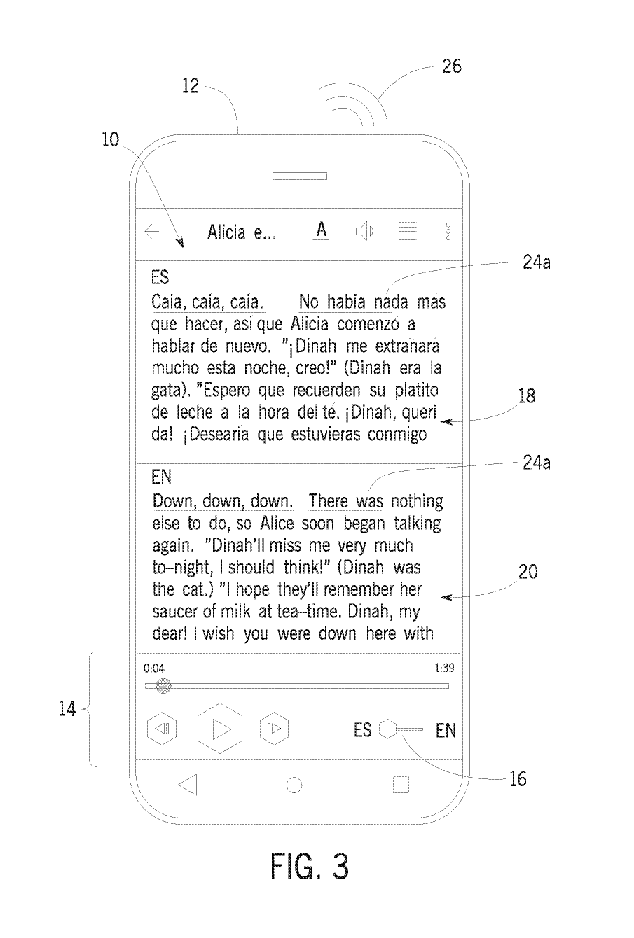

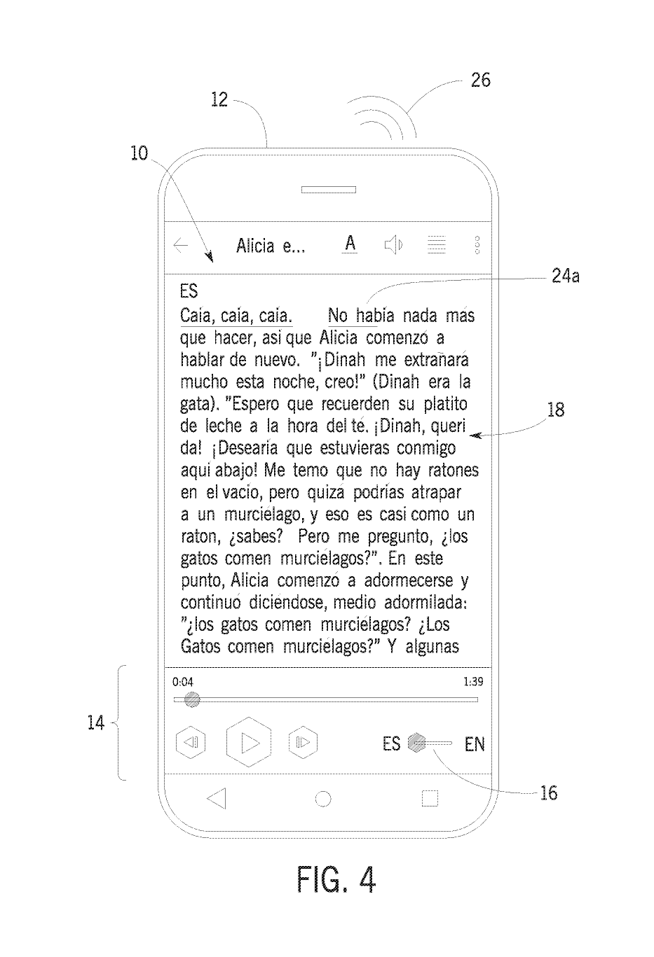

Referring now to FIGS. 1 through 4, the present invention may include at least one computing device 12 with a display medium or device 10. The computing device 12 may include at least one processing unit coupled to a form of memory including. The computing device may include, but is not limited to, a desktop, laptop, and smart device, such as, a tablet and smart phone. The computing device 12 may include a program product including a machine-readable program code for causing, when executed, the computing device 12 to perform steps. The program product may include software which may either be loaded onto the computing device 12 or accessed by the computing device. The loaded software may include an application on a smart device. The software may be accessed by the computing device 12 using a web browser. The computing device 12 may access the software via the web browser using the internet, extranet, intranet, host server, internet cloud and the like.

The display medium 10 may be a user interface, graphical user interface, output device, or the like. The display medium 10 may be adapted to display at least one block of first language data from blocks of first language data 18 as graphical text, as illustrated in the FIGS. When the blocks of first language data 18 comprise a writing of a predetermined number of sentences, each block of first language data may be one sentence. Similarly and simultaneously, the display medium 10 may be adapted represent a translation of each block of first language data 18 in an associated block of second language data 20. The first language data 18 may embody a first language the user is proficient or fluent in, such as a native language, while the second language data 20 embodies a language the user wants to learn more about.

The computing device 12 underlying the display medium 10 may provide logic and/or set of rules to match the blocks of first and second language data 18 and 20, sentence for sentence, so that each sentence of the first language data 18 is associated with a respective sentence of the second language data 20. The computing device 12 may provide an audio output 26 of a person reading the text in both the first and second languages embodied in the blocks of first and second language data 18 and 20, respectively. The computing device 12 may provide logic to synchronize the audio output 26 with a visual output indicator animation 24a and 24b that runs through the text in both the first and second languages 10 and 12. The computing device 12 may provide logic and/or set of rules for a user to select a sentence (block of language data, in certain embodiments) through the display medium 10, for example by touching it and highlighting it in both sides. The computing device 12 may provide logic and/or set of rules for representing the first and second languages 10 and 12 side by side on the display medium 10 at the same time, while running their respective visual output indicator animation 24a and 24b independently, yet selectively controllable through, for example, providing play, pause and other electronic control buttons 14.

The display medium 10 may be adapted to, through the visual output indicator animation 24a and 24b, indicate the current position in the text (block language data) while at the same time maintaining synchronicity with the reproduction of the associated audio representational output 26. In certain embodiments, the present invention may generate a list of milliseconds, for example through a clock signal, that represents the duration of every block of first 18 and/or second 20 language data (in certain embodiments, a standalone sentence of written text). Using that list, the present invention may be adapted to synchronizing the language data, their associate visual output indicator animations 24a and 24b, and their audio output 26 wherever the user may start or pause throughout the representations of the first and second languages on the user display medium 10. With the information from the list of milliseconds the system of the present invention can deduce exactly how long each sentence (block of language data) lasts in each language. Knowing how long each sentence lasts in each language, the system can provide the audio output/reading 26 and create the visual output/animation 24a and 24b over the text going from left to right or right to left (depending on the language) that lasts the exact time that the sentence does, giving the appearance that the visual output/animation 24a and 24b is following the text while it is being read out loud by the voice in the audio output 26. With the information from the list of milliseconds and determining exactly how long each sentence lasts in each language, the system of the present invention can divide each block of language/text data into sentences, and make the sentences be the same number in both blocks of language data. Using that list of milliseconds, the system of the present invention could calculate how long the visual output animation 24a and 24b should last from the beginning to the end of a sentence. By monitoring the millisecond that the audio output 26 is currently playing, the present invention can determine how long to run the visual output animation 24a and 24b. Whereby, the present invention may generate visual output animation 24a and 24b signals representing a current language/text position within a block of language/text data.

The present invention may be adapted so that both languages 10 and 12 may be displayed simultaneously on the display medium 10, but work independently as described above. For example, generating the audio output 26 of a person reading the graphical text of both blocks of first and second language, while simultaneously displaying both texts in the same screen/display medium 10. The user may be enabled to selectively choose between each of the two language/text data block by way of a slider or toggle 16.

The present invention may be adapted so that interfacing with a portion of the first language 18 engages an associated portion of the second language data 20, for example when touching a block or portion thereof the first language/text data 18, say a sentence, the associated sentence in the second language data 20 may be highlighted by way of a highlighter modality 22a and 22b, as illustrated in FIG. 1.

A method of using the present invention may include the following. A computing device may be loaded with the software/logic to provide the functionality disclosed above. With the first and second languages represented via the graphical text of the blocks of language/text data, a user can click on any portion thereof so as to selectively play the associated audio output 26 and/or the visual output indicator animation 24a and/or 24b of only that second language they are learning. Users need to hit the control input 14 to make the audio output 26 play. They may monitor the visual output indicator animation of both native language and learning language, to see which side is running. Users can click on a sentence to highlight it. Users can press the pause button to make the audio output 26 paused and highlight the currently playing sentence. Users can click on a highlighted sentence to play the audio of only that sentence in the language they are learning.

Additionally, the present invention could be used as user manuals of machines or software that have complicated procedures to show users these instructions in their native language. The present invention could also be used by teachers in language schools to help students read along a text in the language they are learning

The computing device-based data processing system and method described above is for purposes of example only, and may be implemented in any type of computing device system or programming or processing environment, or in a computing device program, alone or in conjunction with hardware. The present invention may also be implemented in software stored on a computing device-readable medium and executed as a computing device program on a general purpose or special purpose computing device. For clarity, only those aspects of the system germane to the invention are described, and product details well known in the art are omitted. For the same reason, the computing device hardware is not described in further detail. It should thus be understood that the invention is not limited to any specific computing device language, program, or computing device. It is further contemplated that the present invention may be run on a stand-alone computing device system, or may be run from a server computing device system that can be accessed by a plurality of client computing device systems interconnected over an intranet network, or that is accessible to clients over the Internet. In addition, many embodiments of the present invention have application to a wide range of industries. To the extent the present application discloses a system, the method implemented by that system, as well as software stored on a computing device-readable medium and executed as a computing device program to perform the method on a general purpose or special purpose computing device, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the present invention.

What is claimed is:

1. A system for teaching a language, comprising:
a display device displaying at least one block of second language data in synchronization with a reproduction of audio output associated with the at least one block of second language data;
a form of memory coupled to the display device, wherein a block of first language data translated in response to each of the at least one block of second language data is retrievable stored so that each block of first language data is selectively displayable on the display device simultaneously with said display of the at least one block of second language data; and
an animation generator for generating output signals representing a current language position within each block of first and/or second language data associated with the reproduction of audio output.

2. The system for teaching a language of claim 1, further comprising control inputs operatively associated with the display device, wherein the control inputs are configured selectively display each block of second language data adjacent to each said block of first language text.

3. The system for teaching a language of claim 1, wherein the display device is configured to highlight each block of first and second language text simultaneously.

4. The system for teaching a language of claim 1, wherein each block of first and second language data is a representation of the text of a first and second language, respectively.

5. The system for teaching a language of claim 1, wherein the audio output is a human voice reading each block of the second language data.

6. The system for teaching a language of claim 1, wherein the output signals are visual indicators displayed on the display device adjacent to the current language position.

7. A system for teaching a language, comprising:
a display device displaying at least one block of second language data in synchronization with a reproduction of audio output associated with the at least one block of second language data;
a form of memory coupled to the display device, wherein a block of first language data translated in response to each of the at least one block of second language data is retrievable stored so that each block of first language data is selectively displayable on the display device simultaneously with said display of the at least one block of second language data;
an animation generator for generating output signals representing a current language position within each block of first and/or second language data associated with the reproduction of audio output, wherein the output signals are visual indicators displayed on the display device adjacent to the current language position; and
control inputs operatively associated with the display device, wherein the control inputs are configured selectively display each block of second language data adjacent to each said block of first language text, wherein the display device is configured to highlight each block of first and second language text simultaneously.

8. The system for teaching a language of claim 7, wherein each block of first and second language data is a representation of the text of a first and second language, respectively.

9. The system for teaching a language of claim 7, wherein the audio output is a human voice reading each block of the second language data.
